(19) United States
(12) Patent Application Publication
(10) Pub. No.: US 2011/0138579 A1
(43) Pub. Date: Jun. 16, 2011

(54) SLIDING ASSIST MECHANISM

(76) Inventor: Masakazu Sato, Kanagawa (JP)

(21) Appl. No.: 12/737,014

(22) PCT Filed: Jun. 5, 2009
(86) PCT No.: PCT/JP2009/060337

§ 371 Date: Feb. 24, 2011

(30) Foreign Application Priority Data
Jun. 6, 2008 (JP) 2008-149908

(51) Int. Cl. E05F 1/16; E05C 1/08

(52) U.S. Cl. 16/93 R; 292/164

(57) ABSTRACT

A sliding assist mechanism includes a case (1) attached to one of a main body (7) and a mobile body (A); a latch (4) movably disposed in the case and switched between a standby state in which the latch is locked in the case and a retracted state in which the locking is released; a biasing device (3) for biasing the latches in one direction; and an operation member (8) attached to the other of the main body (7) and the mobile body. When the latch (4) is switched.from the standby state to the retracted state, the sliding assist mechanism allows the mobile body to move from a first position to a second position on a main body side through the operation member (8) by biasing force accumulated in the biasing means (3). Essential parts of the mechanism include an engagement portion (42) at a normal time when the latches (4) engage the operation members (8) by interlocking the switching from the standby state to the retracted state, and an auxiliary engagement device (47) releasably engages the operation members (8) when the latch comes to the retracted state in a non-engaged state of the operation member relative to the engagement portion. A repairing structure can be further simplified by such sliding assist mechanism.

### FIELD OF TECHNOLOGY

This invention relates to a sliding assist mechanism which assists an operation of switching a mobile body from a first position on a main body side to a second position or from the second position to the first position.

### BACKGROUND ART

FIGS. 14(a) and 14(b) are drawings showing an assist mechanism disclosed in Patent Document 1. The reference numeral 121 represents a sliding door closer attached to an upper side of a retaining frame on the main body side, and the reference numeral 103 represents an operation member (engagement pin) provided on a sliding door side which is the mobile body. Here, the closer 121 comprises a case 122, a hook body 136, and biasing means 135. The case 122 has a container shape and forms an engagement groove portion 125 extending in a longitudinal direction from one end side, and a sliding groove portion 131 (comprising a linear moving groove portion 132 and a rotating groove portion 133 which is folded back at one end side of the moving groove portion 132). The hook body 136 includes a retaining depression 146 engaging and disengaging the operation member 103, and engaging projections 144, 145 fitted in the sliding groove portion 131. The biasing means 135 urges the hook body 136 to the other end side of the sliding groove portions 131 in a state wherein one end is locked in the hook body 136 and the other end is locked in a case 122 side. The biasing means 135 accumulates a biasing force in a process in which the sliding door slides from a closing direction to an opening direction. The operation member 103 is the engagement pin projecting relative to an upper end face of the sliding doors through an automatic return mechanism 104.

Then, in this assist mechanism, the operation member 103 is moved toward the sliding door closer 121 on the main body side by a closing operation of the sliding door. Then, after the operation member 103 is entered in the engagement groove portion 125 and slid, the operation member 103 is engaged with the retaining depression 146 of the hook body 136 and retained. Specifically, the hook body 136 is rotated as a center of the engaging projection 145 by stress received from the operation member 103 from a standby state in FIG. 14(a), and as in FIG. 14(b), the engaging projection 144 is fitted in the moving groove portion 132 from the rotating groove portion 133, and switched to a retracted state. Then, the hook body 136 is slid to a back end side of the case 122 by a biasing force of the biasing means 135 in the retracted state, i.e., in a state wherein the hook body 136 holds the operation member 103. Also, from this state, due to an opening operation of the sliding door, the operation member 103 is slid to a front end side of the case 122 with the hook body 136. With that, the biasing means 135 accumulates the biasing force. Further, when the sliding door is moved in the opening direction, the hook body 136 comes to the state in FIG. 14(a) again.

In the above-mentioned assist mechanism, there is a possibility that the hook body 136 rotates abruptly due to a vibration and the like from the standby state, and comes to the retracted state in a non-engaged state of the operation member 103 relative to the retaining depression 146 (hereinafter, this is called the retracted state of the non-engaged state). In that case, even if the operation member 103 is slid along the engagement groove portion 125, the operation member 103 cannot be engaged with the retaining depression 146. As a repairing structure thereof, a widened groove portion 126 for guiding provided at a back side of the engagement groove portion 125, and the automatic return mechanism 104 as a support mechanism of the operation member 103, are provided. In the automatic return mechanism 104, the operation member 103 can be slid along a sliding bore 108 of a plate 105 through a rotating disk and the like (not shown), and is pressed against one end side of the sliding bore 108 by a biasing force due to a winding spring (not shown). In this operation, in the retracted state of the non-engaged state of the hook body 136, after the operation member 103 is entered in the engagement groove portion 125 by the closing operation of the sliding door and abuts against an inclined surface portion 147 on a hook body side, the operation member 103 can be engaged with the retaining depression 146 while being guided to the widened groove portion 126 through the automatic return mechanism 104.

### Prior Art Document

### Patent Document

Patent Document 1: Japanese Patent Application Laid-Open Publication No. 2005-290769

### SUMMARY OF THE INVENTION

### Problems to be Solved by the Invention

In the above-mentioned assist mechanism, when the closing operation of the sliding door is carried out, the sliding door is automatically switched to a closed position from a middle by the biasing force of the biasing means 135, so that an occurrence of an incomplete closed state of the sliding door can be reliably resolved. However, the above-mentioned repairing structure not only becomes complex since the automatic return mechanism 104 supports the operation member 103 to be capable of swaying in a thickness direction of the sliding door. Also, for example, as in FIG. 14(b), in a stage in which the hook body 136 is engaged with the operation member 103 in the retracted state and the sliding door is operated to be moved in the opening direction and not yet reached the rotating groove portion 133, when an impact is made in the thickness direction of the sliding door, there is a possibility that the operation member 103 is disengaged from the retaining depression 146 through the automatic return mechanism 104 and the widened groove portion 126. This is caused by that the sliding door is movably supported with a predetermined gap relative to a guide portion on the main body side; that when the sliding door is operated to be opened and closed, the sliding door easily receives a change of load in a door thickness direction; and that a diameter of the operation member 103 and a depth of the retaining depression 146 are restricted.

Incidentally, by applying the above-mentioned assist mechanism to double sliding doors in which right-and-left sliding doors A, B, for example, as shown in FIG. 8 are opened and closed by double sliding, in a case in which each sliding door A, B is automatically retracted in the closed position from the middle and an open position from the middle, respectively, the sliding door closer 121 is required to be attached in at least four places on the main body side. Therefore, installation man-hours and installation costs increase. In order to solve such problems, the present applicants have developed an assist mechanism in which the sliding door can be automatically retracted at, for example, both times of closing and opening the sliding door while reducing the installation man-hours and the installation costs (a mechanism disclosed in Japanese Patent Application Laid-Open Publication No. 2008-144567, hereinafter, this is called an “assist mechanism of both directions”).

An object of the present invention is to provide a sliding assist mechanism which can be used for a further wide range of usage and excels in usability by comprising a repairing structure which has a further simple structure, and can easily apply to the above-mentioned assist mechanism of both directions as well compared to the above-mentioned repairing structure.

### Means for Solving the Problems

In a first embodiment of the present invention which achieves the above-mentioned object, a sliding assist mechanism comprises a case attached to one of a main body and a mobile body; a latch movably disposed in the above-mentioned case and switched between a standby state in which the latch is locked in a corresponding portion inside the case and a retracted state in which the above-mentioned locking is released; biasing means for biasing the above-mentioned latch in one direction; and an operation member attached to the other of the above-mentioned main body and the mobile body, and switching the above-mentioned latch from the standby state to the retracted state, or from the retracted state to the standby state. When the above-mentioned latch is switched from the standby state to the retracted state, the sliding assist mechanism allows the above-mentioned mobile body to move from a first position to a second position on a main body side through the above-mentioned operation member by a biasing force accumulated in the above-mentioned biasing means. The above-mentioned latch includes auxiliary engagement means which engages the above-mentioned operation member to be capable of releasing when the latch comes to the retracted state in a non-engaged state of the above-mentioned operation member relative to an engagement portion with the engagement portion at a normal time when the latch engages the above-mentioned operation member by interlocking the switching from the standby state to the retracted state.

Also, in a second embodiment of the present invention which achieves the above-mentioned object, a sliding assist mechanism comprises a case attached to one of a main body and a mobile body; a pair of latches respectively disposed in the above-mentioned case to be movable, and switched between a standby state in which the latches are locked in a corresponding portion inside the case and a retracted state in which the above-mentioned locking is released; biasing means for biasing in a direction in which the above-mentioned latches are approached to each other; and an operation member attached to the other of the above-mentioned main body and the mobile body, and switching the above-mentioned latches from the standby state to the retracted state, or from the retracted state to the standby state. When the above-mentioned mobile body is moved to a middle of the movement from a first position to a second position on a main body side or up to the middle from the second position to the first position, one latch releases the above-mentioned locking through the above-mentioned operation member, and with the operation member, the sliding assist mechanism allows the mobile body to move up to the second position or the first position with an approaching drive through a biasing force of the above-mentioned biasing means toward the other latch. The above-mentioned latches include auxiliary engagement means which engages the above-mentioned operation member to be capable of releasing when the latches come to the retracted state in the non-engaged state of the above-mentioned operation member relative to the above-mentioned engagement portion with the engagement portion at the normal time when the latches engage the above-mentioned operation member by interlocking the switching from the standby state to the retracted state.

In the sliding assist mechanism according to the above-mentioned embodiment, as for the mobile body, a drawer and the like is included besides the sliding door. As for the main body, a frame for the sliding door, a storage portion for the drawer, and the like are also included. The first position shows a completely closed position or completely open position of the mobile body, and this also includes the closed position where the mobile body is completely pushed into the storage portion or the open position where the mobile body is completely pulled out of the storage portion. The second position shows the completely open position or completely closed position of the mobile body, and this also includes the open position where the mobile body is completely pulled out of the storage portion or the closed position where the mobile body is completely pushed into the storage portion. The auxiliary engagement means allows the latches to be switched from the retracted state to the standby state again by engaging the operation member when the latches come to the retracted state without engaging the operation member with the engagement portion. Incidentally, as in the actual embodiments, the auxiliary engagement means is provided on an opposite side of a biasing direction of the biasing means among the latches, and engages the operation member in the retracted state of the non-engaged state of the latches. Also, in the sliding assist mechanism according to the above-mentioned embodiments, the case, the latches, and the biasing means are structured as a retracting unit as shown in the embodiments or Patent Document 1.

The sliding assist mechanism according to the above-mentioned embodiment is preferably embodied as follows.

(A) A structure including a slider slidably disposed relative to the above-mentioned case, and rotatably supporting the above-mentioned latch.

(B) A structure wherein the above-mentioned operation member is a projecting body provided so as to be capable of freely coming in and out relative to the above-mentioned main body or the mobile body through a biasing force, and wherein the above-mentioned auxiliary engagement means comprises an inclined-surface guide portion formed in the above-mentioned latch and guiding the above-mentioned projecting body, and a depressed portion which continues into the inclined-surface guide portion.

(C) A structure wherein the above-mentioned auxiliary engagement means absorbs and engages the above-mentioned operation member by a magnetic force.

(D) A structure wherein the above-mentioned latch has a portion forming the above-mentioned engagement portion made by a material different from that of the other portions. In this case, more preferably, the portion forming the above-mentioned engagement portion is structured so as to be softer than the other portions.

### Effect of the Invention

In the sliding assist mechanism according to the above-mentioned first embodiment, even if the latch comes to the retracted state of the non-engaged state by an improper operation, the operation member engages the auxiliary engagement means provided on the latch, and allows the latch to be switched from the retracted state to the standby state again. As a: repairing structure, this auxiliary engagement means is not required for an additional processing for a case side compared to the above-mentioned conventional repairing structure, and also since the operation member is not required to be supported to be capable of swaying in a thickness direction of the mobile body, the auxiliary engagement means is simple and can be implemented with reducing costs.

In the sliding assist mechanism according to the above-mentioned second embodiment, as an assist mechanism in which the mobile body is switched respectively to the second position or the first position on the middle in which the mobile body is switched from the first position on the main body side to a second positional direction, and on the middle in which the mobile body is switched from the second position to a first positional direction, i.e., by automatically retracting the mobile body from the middle by the biasing force of the biasing means, the same advantages as the invention of the above-mentioned first aspect can be provided.

Also, by providing the above-mentioned feature (A), the latch is rotatably supported relative to the slider which was moved through the slider, so that the above-mentioned retracting operation and a repairing operation can be reliably obtained.

Also, by providing the above-mentioned feature (B), as in the embodiment of the present invention shown in FIGS. 1 to 11, the operation member comprises the projecting body coming in and out through the biasing force, and the auxiliary engagement means comprises the inclined-surface guide portion guiding the projecting body, and the depressed portion which continues into the inclined-surface guide portion, so that the implementation can be easily carried out. On the other hand, also, by providing the above-mentioned feature (C), as in a modified example of FIG. 13(b), by using a magnetic force operation, the implementation can be easily carried out.

Also, by providing the above-mentioned feature (D), as for the latch, if the portion forming the engagement portion is formed so as to be harder than the other portions, an impact characteristic and durability relative to the operation member can be improved. On the other hand, if the portion forming the engagement portion is formed so as to be softer than the other portions, a hitting noise caused by the bumping of the operation member can be prevented.

### BRIEF DESCRIPTION OF THE DRAWINGS

FIG. 1(a) is a bottom view of a retracting unit 6 according to an embodiment of the present invention.

FIG. 1(b) is a side view of the retracting unit 6.

FIG. 1(c) is one side end view of the retracting unit 6.

FIG. 2 is an exploded structural view of the retracting unit 6.

FIG. 3 is a plan view showing a state wherein a cover 15 is removed from the retracting unit 6.

FIG. 4(a) is a schematic perspective view of a slider 2A structuring the retracting unit 6.

FIG. 4(b) is a schematic perspective view wherein the slider 2A is viewed from a direction different from FIG. 4(a).

FIG. 5(a) is a schematic perspective view of a slider 2B structuring the retracting unit 6.

FIG. 5(b) is a schematic perspective view wherein the slider 2B is viewed from a direction different from FIG. 5(a).

FIG. 6(a) is a top view of a latch 4 (latch on a slider 2A side) structuring the retracting unit 6.

FIG. 6(b) is a front view of the latch 4 (latch on the slider 2A side) structuring the retracting unit 6.

FIG. 6(c) is a bottom view of the latch 4 (latch on the slider 2A side) structuring the retracting unit 6.

FIG. 6(d) is a rear view of the latch 4 (latch on the slider 2A side) structuring the retracting unit 6.

FIG. 7(a) is an enlarged sectional view of a cross-sectional surface of B-B shown in FIG. 6(c).

FIG. 7(b) is an enlarged sectional view of a cross-sectional surface of A-A shown in FIG. 6(c).

FIG. 7(c) is an enlarged sectional view of a cross-sectional surface of C-C shown in FIG. 6(d).

FIG. 8(a) is a pattern diagram showing an example of the application of the retracting unit 6.

FIG. 8(b) is an exploded view of projecting bodies 8 which are operation members used for the retracting unit 6.

FIG. 9(a) is a drawing showing a relationship of a frame on a main body 7 side, the retracting unit 6, and the projecting bodies 8 (operation members).

FIG. 9(b) is a drawing showing the relationship of the frame on the main body 7 side, the retracting unit 6, and the projecting bodies 8 (operation members).

FIG. 9(c) is a drawing showing the relationship of the frame on the main body 7 side, the retracting unit 6, and the projecting bodies 8 (operation members).

FIG. 10(a) is a drawing wherein the latch 4 in a standby state is viewed from an upper side.

FIG. 10(b) is a drawing wherein the latch 4 in the standby state is viewed from a lower side.

FIG. 11(a) is a drawing wherein the latch 4 in a retracted state is viewed from an upper side.

FIG. 11(b) is a drawing wherein the latch 4 in a retracted state is viewed from a lower side.

FIG. 12(a) is a drawing schematically showing an operation when the projecting bodies 8 (operation members) are engaged with the latch 4 in the retracted state (state shown in FIG. 9(c)).

FIG. 12(b) is a drawing three-dimensionally showing an operation shown in FIG. 12(a).

FIG. 13(a) is a drawing showing a first modified example of the embodiment of the present invention.

FIG. 13(b) is a drawing showing a second modified example of the embodiment of the present invention.

FIG. 14(a) is an explanatory view showing essential parts of an assist mechanism disclosed in Patent Document 1.

FIG. 14(b) is an explanatory view showing the essential parts of the assist mechanism disclosed in the Patent Document 1.

### BEST MODE OF CARRYING OUT THE INVENTION

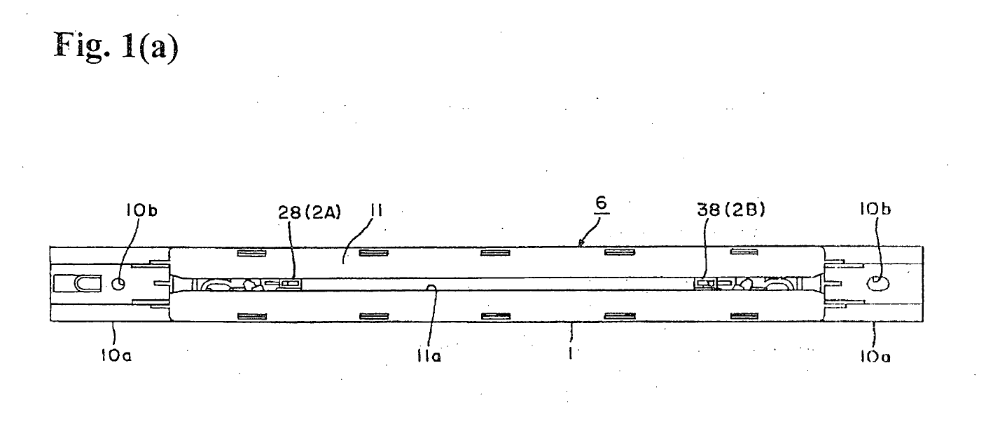

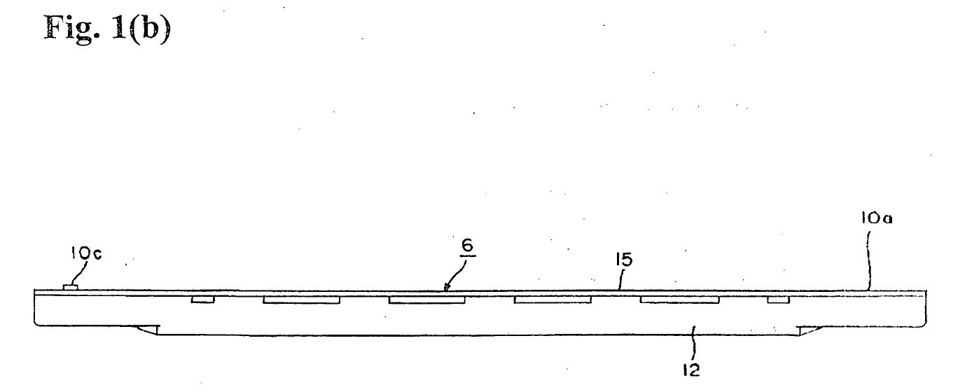

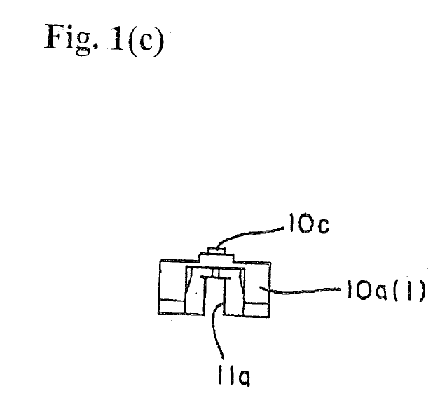

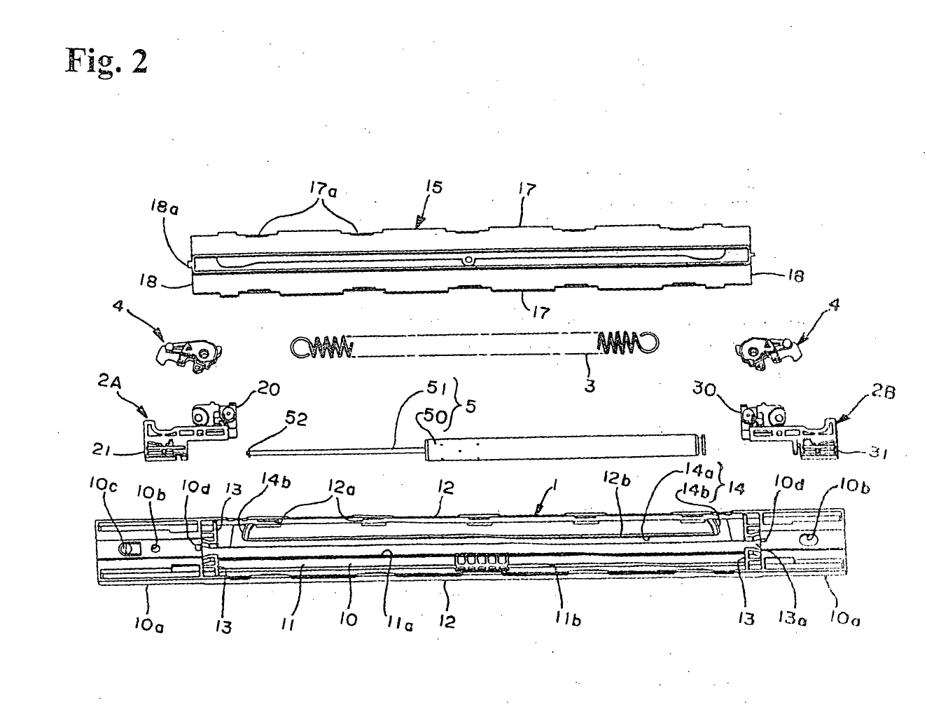

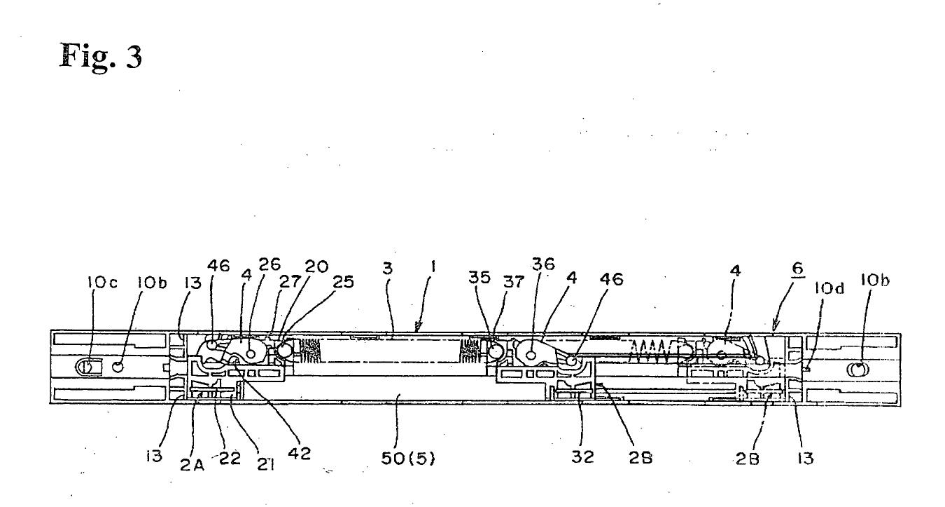

Embodiments of the present invention will be explained with reference to drawings. FIG. 1(a) is a bottom view of a retracting unit 6 which becomes an essential part of a sliding assist mechanism according to the embodiment of the present invention. Also, FIG. 1(b) is a side view of the retracting unit 6, and FIG. 1(c) is one side end view of the retracting unit 6. Also, FIG. 2 is an exploded structural view of the retracting unit 6. Also, FIG. 3 is a plan view showing a state wherein a cover 15 is removed from the retracting unit 6. Incidentally, in FIG. 3, a latch 4 on a right side is in a retracted state.

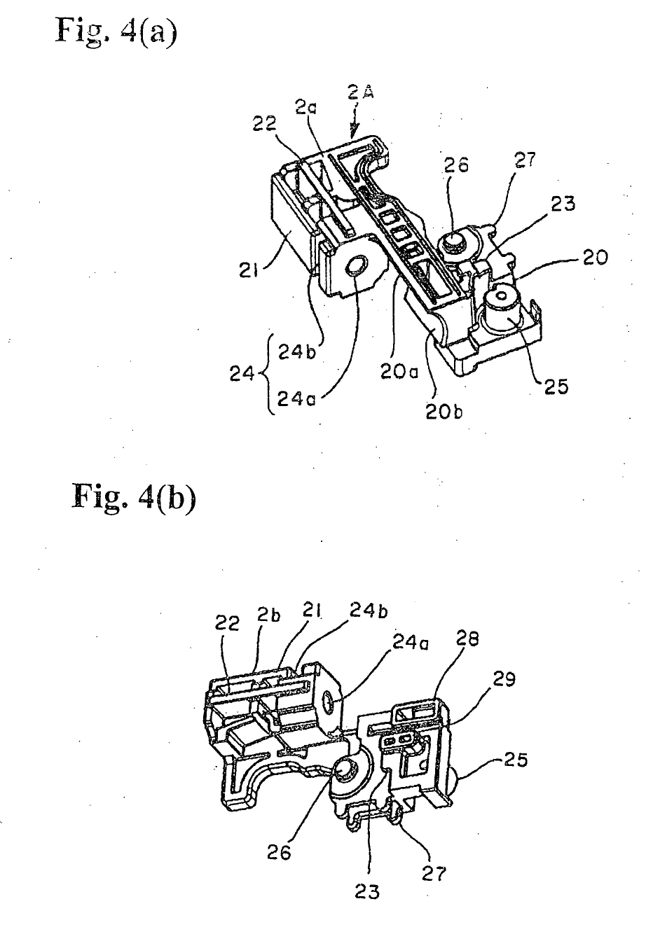

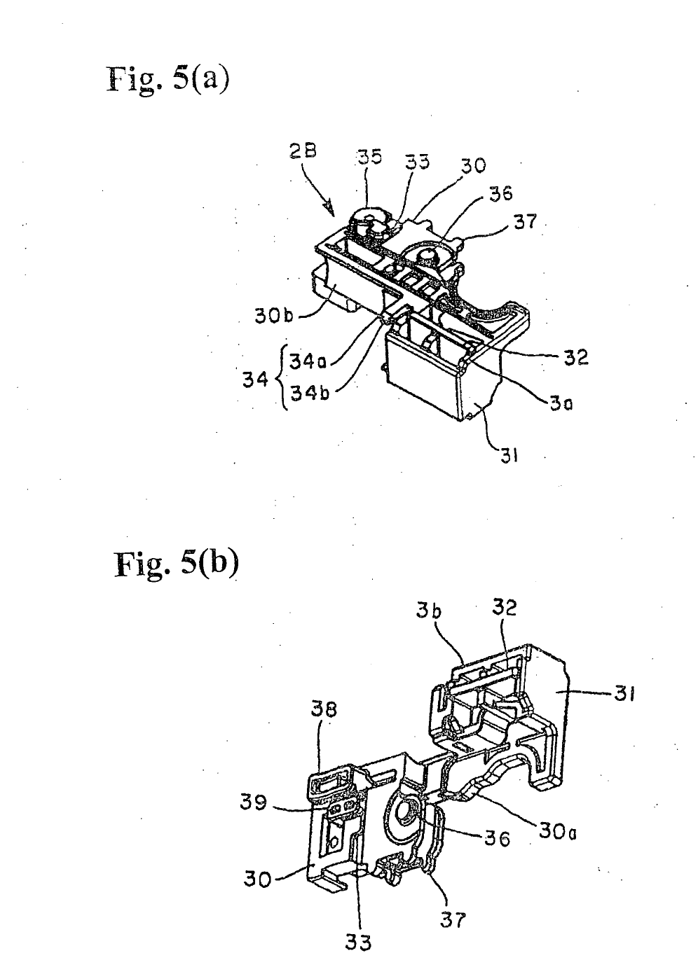

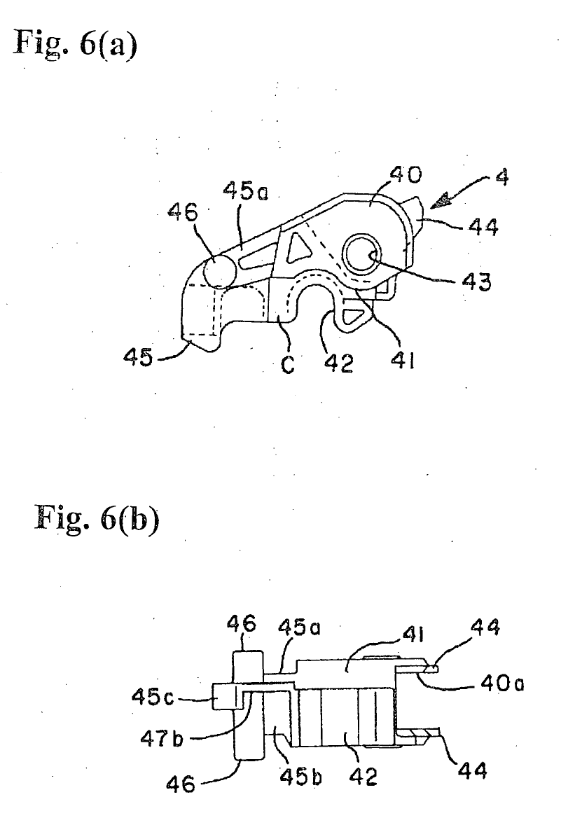

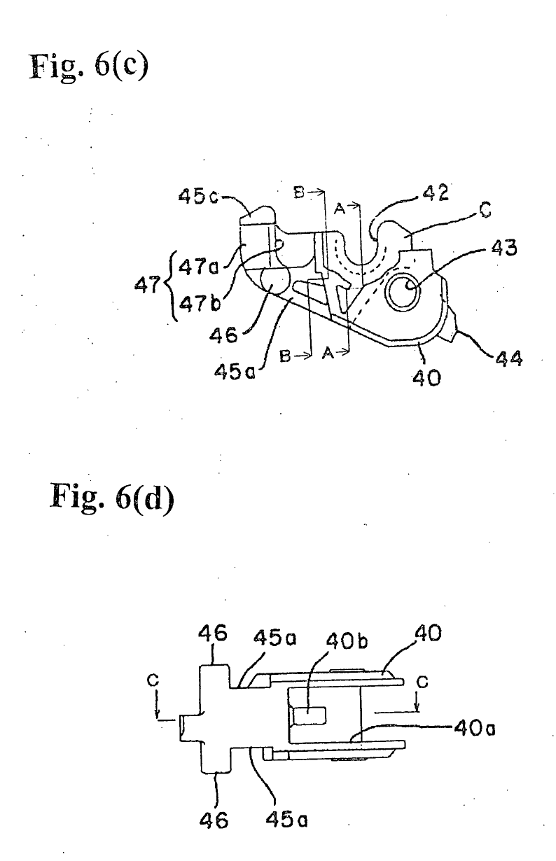

Also, FIG. 4(a) is a schematic perspective view of a slider 2A structuring the retracting unit 6. FIG. 4(b) is a schematic perspective view wherein the slider 2A is viewed from a direction different from FIG. 4(a). Also, FIG. 5(a) is a schematic perspective view of a slider 2B structuring the retracting unit 6. FIG. 5(b) is a schematic perspective view wherein the slider 2B is viewed from a direction different from FIG. 5(a). Also, FIGS. 6(a) to 6(d) are a top view, a front view, a bottom view, and a rear view of a latch 4 (latch on a slider 2A side) structuring the retracting unit 6, respectively.

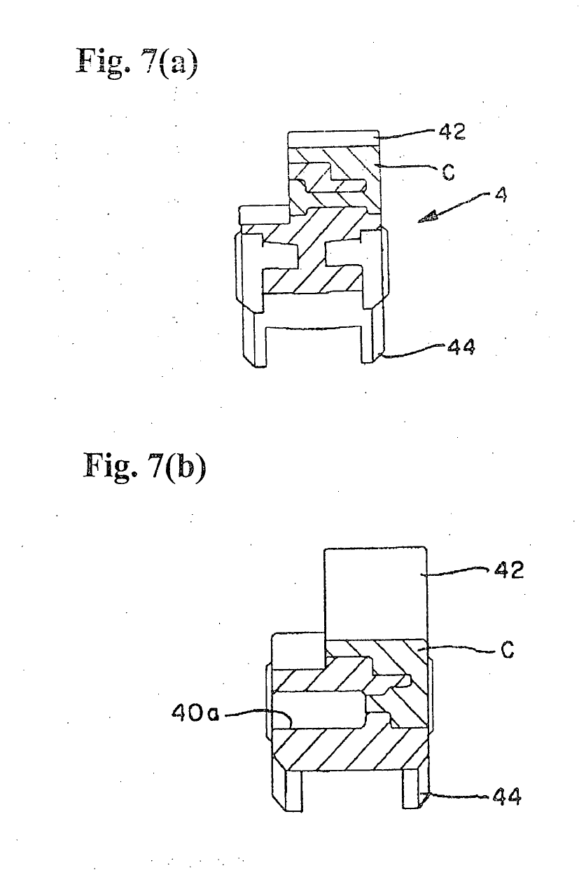

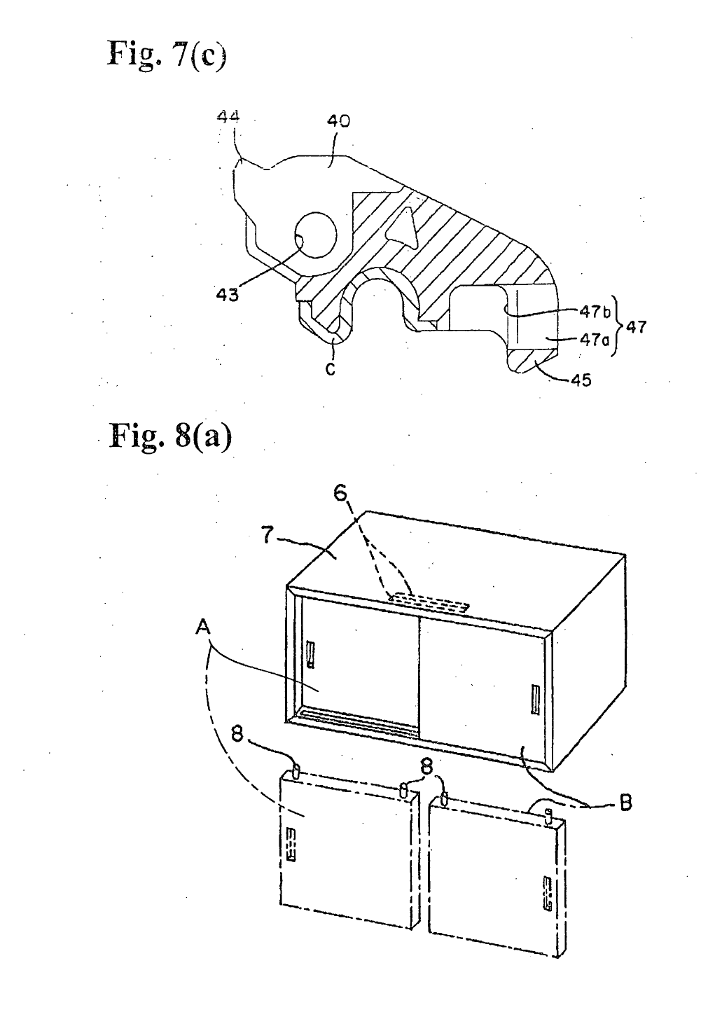

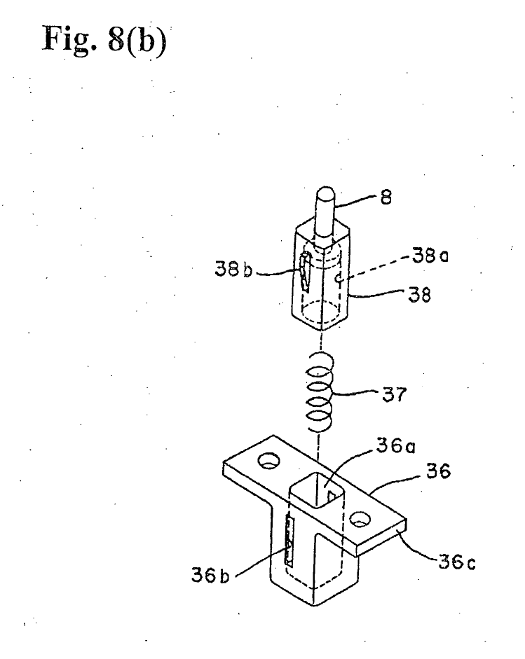

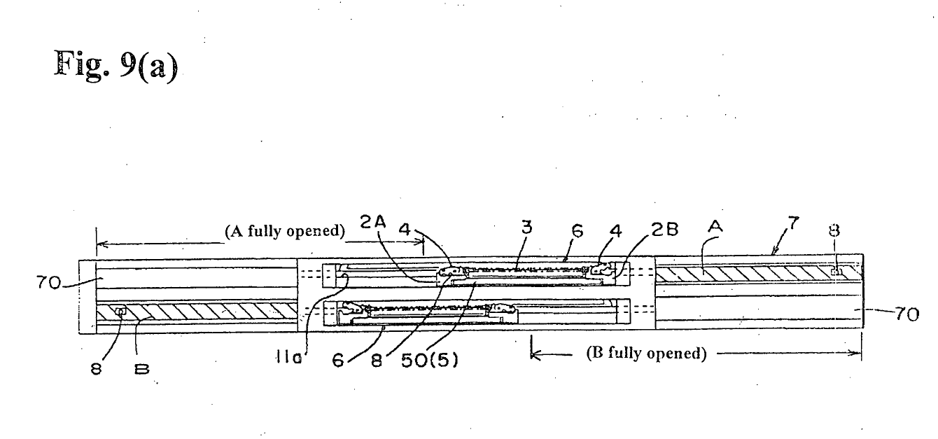

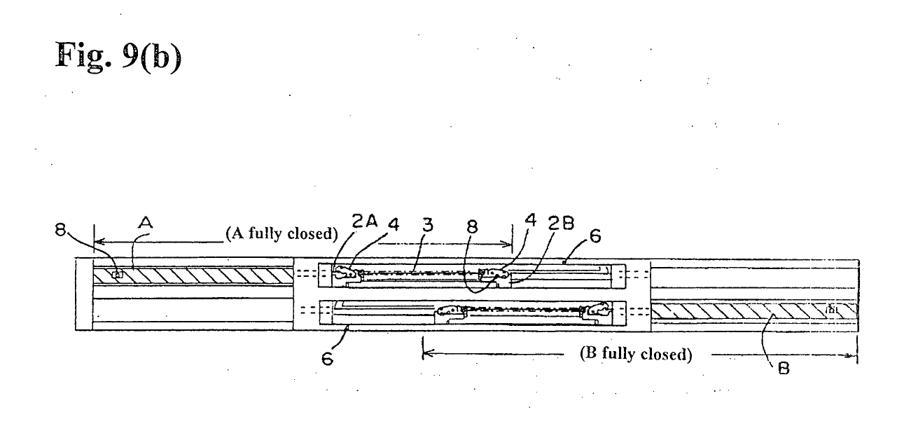

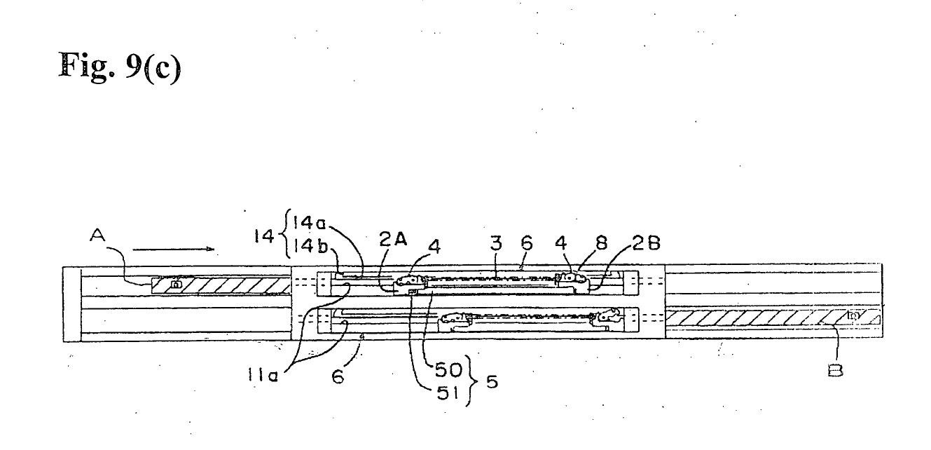

Also, FIG. 7(a) is an enlarged sectional view of a cross-sectional surface of B-B shown in FIG. 6(c). Also, FIG. 7(b) is an enlarged sectional view of a cross-sectional surface of A-A shown in FIG. 6(c). Also, FIG. 7(c) is an enlarged sectional view of a cross-sectional surface of C-C shown in FIG. 6(d). Also, FIG. 8(a) is a pattern diagram showing an example of the application of the retracting unit 6. Also, FIG. 8(b) is an exploded view of projecting bodies 8 which are operation members used for the retracting unit 6. Also, FIGS. 9(a) to 9(c) are drawings showing a relationship of a frame on a main body 7 side, the retracting unit 6, and the projecting bodies 8 (operation members). Incidentally, FIG. 9(a) is a pattern diagram of fully opened double sliding doors which are switched to an open position; FIG. 9(b) is a pattern diagram of fully closed double sliding doors which are switched to a closed position; and FIG. 9(c) is a pattern diagram showing a state wherein a latch 4 on a left side comes to the retracted state from a state shown in FIG. 9(b) by an improper operation.

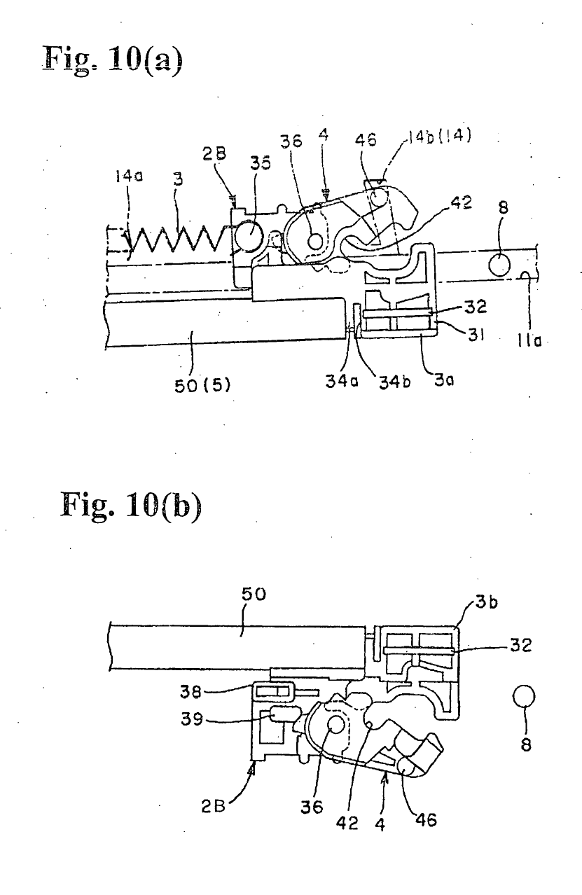

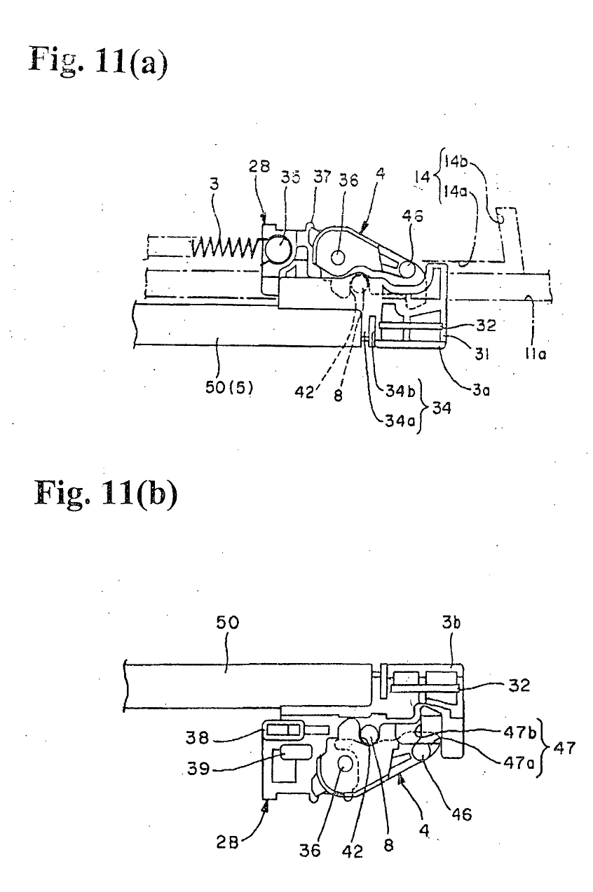

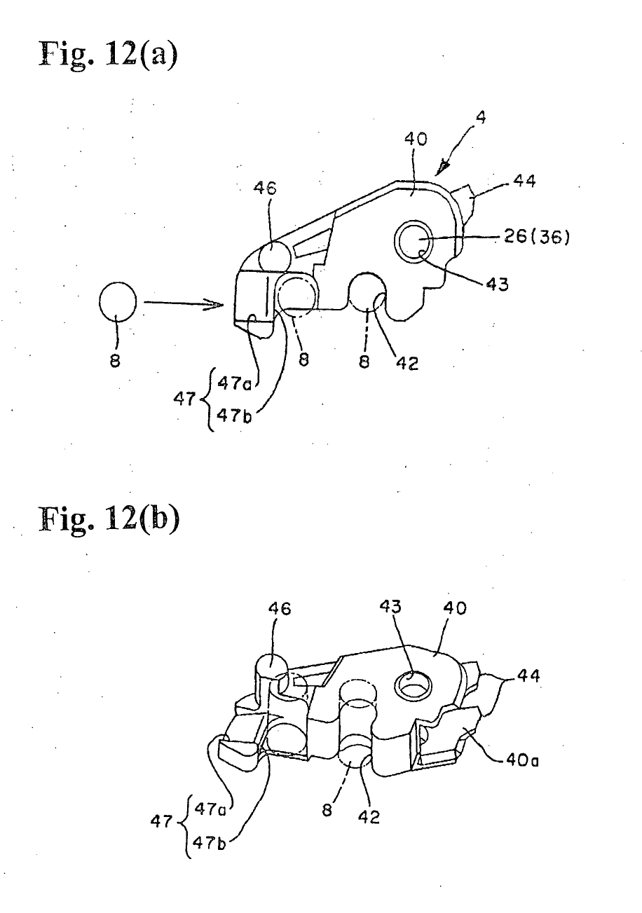

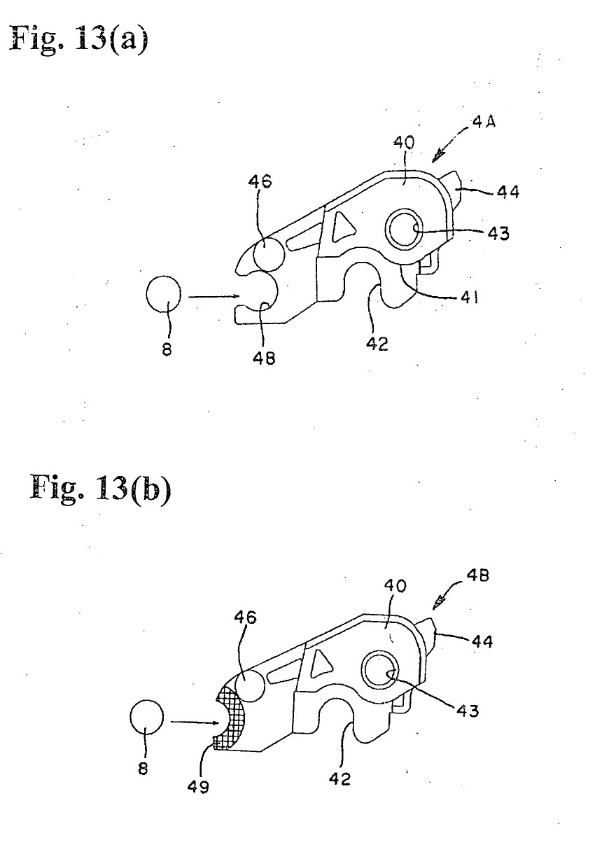

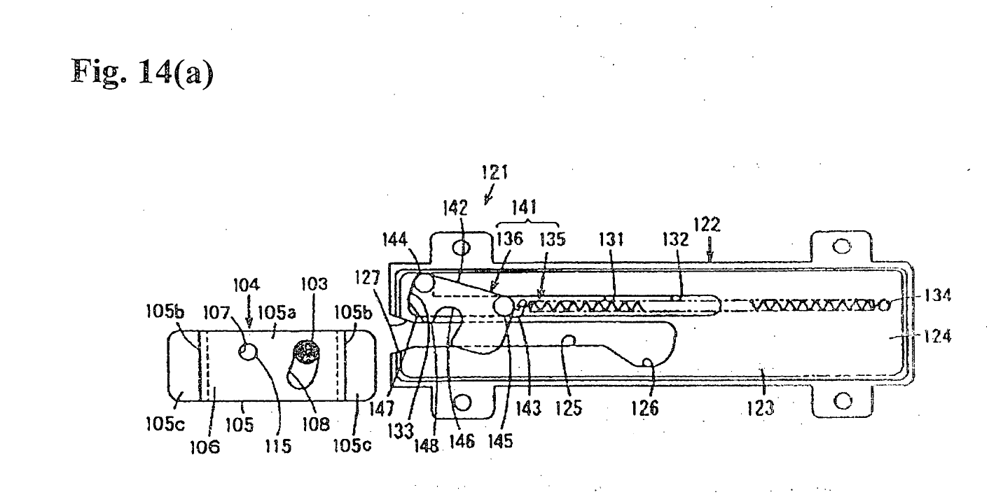

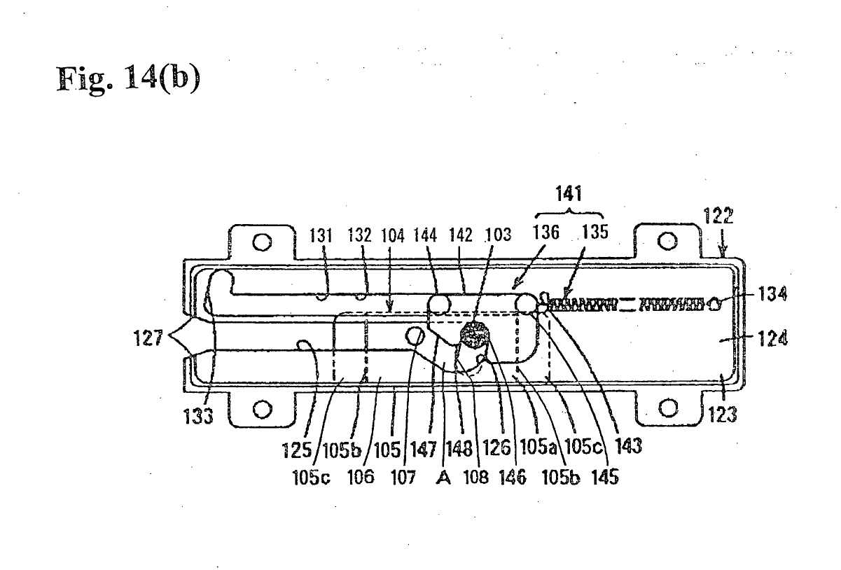

Also, FIGS. 10(a) and 10(b) are drawings wherein the latch 4 in a standby state is viewed from an upper side and a lower side, respectively. Also, FIGS. 11(a) and 11(b) are drawings wherein the latch 4 in the retracted state is viewed from the upper side and the lower side, respectively. Also, FIG. 12(a) is a drawing schematically showing an operation when the projecting bodies 8 (operation members) are engaged with the latch 4 in the retracted state (state shown in FIG. 9(c)), and FIG. 12(b) is a drawing three-dimensionally showing an operation shown in FIG. 12(a). Also, FIG. 13(a) is a drawing showing a first modified example of the embodiment of the present invention, and FIG. 13(b) is a drawing showing a second modified example of the embodiment of the present invention. Hereinafter, mechanism features, a retracting unit, the operation members, assembly, main operations, and modified examples will be explained in detail in that order.

(Mechanism Features)

The sliding assist mechanism of the present invention comprises the retracting unit 6 attached to a main body 7 or the sliding doors A (B) as mobile bodies, and the projecting bodies 8 as the operation members attached to the main body 7 or the sliding doors A (B). In the following embodiment, a case in which the retracting unit 6 is attached to the main body 7 and the projecting bodies 8 are attached to the sliding doors A (B), is shown. However, the retracting unit 6 can be attached to the sliding doors A (B) and the projecting bodies 8 can be attached to the main body 7. Also, the retracting unit 6 comprises a case 1, the sliders 2, the latches 4, biasing means 3, and braking means 5. However, for example, the sliders 2 and the braking means 5 can be omitted as in Patent Document 1.

Here, the main body 7 is, for example, a kitchen, a shelf, and the like including an opening, or a desk, a copier, and the like including a storage space. The mobile bodies are not limited to the sliding doors A, B, and may be a drawer body for storage and the like. The mobile bodies are slidably disposed between the closed position (which is a fully closed position and corresponds to a pushed-in position in the case of the drawer body) and the open position (which is a fully open position and corresponds to a pulled-out position in the case of the drawer body) along a guide rail provided in the opening or the storage space of the main body 7. Also, the retracting unit and the projecting bodies 8 are divided broadly into the following three kinds of structures according to a subject mobile body or a retracting operational setting.

In a first structure, as shown in FIGS. 1(a) to 7(c), the retracting unit 6 and the two projecting bodies 8 are used as a pair. The retracting unit 6 is provided with a pair of sliders 2A, 2B slid in a direction of separating from each other; the biasing means 3 biasing both sliders 2A, 2B in a direction of approaching to each other; the braking means 5 braking a sliding speed of each slider 2A, 2B; and a pair of latches 4, 4 which can retain both sliders 2A, 2B in a state wherein the sliders 2A, 2B are spaced apart by being rotatably supported by each slider 2A, 2B and being releasably locked in a corresponding portion inside the case 1, respectively. Specifically, this structure is used in a case such as one of the sliding doors A, B in FIG. 8(a) as the mobile body, for example, the single sliding door A is slid relative to the opening corresponding to the main body 7. On the way when the sliding door A is moved from the closed position in an opening direction, and when the sliding door A is moved up to a middle in a closing direction from the open position, after that, the sliding door A can be moved up to the open position or the closed position due to a biasing force of the biasing means 3. Incidentally, the invention of the second aspect is specified with an assumption of the above-mentioned structure.

A second structure is used in a case such as when the sliding doors A, B in FIG. 8(a) as the mobile bodies are respectively slid relative to the opening corresponding to the main body 7. In FIG. 8(a), two retracting units 6 and a total of four projecting bodies 8 are used as a pair; however, instead of those, in the second structure, the retracting unit 6 corresponding to the sliding door A and structural members except for each case 1 of the retracting unit 6 corresponding to the sliding door B are assembled to a common case (refer to Japanese Patent Application Laid-Open Publication No. 2008-144567). Specifically, this retracting unit is based on a unit comprising a pair of sliders 2A, 2B which is slid in a direction of separating from each other; biasing means 3 biasing both sliders 2A, 2B in a direction of approaching to each other; braking means 5 braking a sliding speed of each slider 2A, 2B; and a pair of latches 4, 4 which can retain both sliders 2A, 2B in a state wherein the sliders 2A, 2B are spaced apart by being pivotally supported at each slider 2A, 2B respectively and being releasably locked in a case 1 side. In the second structure, these two pairs are disposed relative to the same case. This can be easily understood according to the following structures, so that the explanation of the second structure itself is omitted.

As disclosed in the Patent Document 1, a third structure is used in a case such as when the mobile body is retracted only in one direction. This retracting unit 6 is the simplest structure in that, for example, in FIG. 3, one of the sliders 2A, 2B is omitted; one end of the biasing means 3 is locked in the slider and the other end of the biasing means 3 is locked in a case side; and one end of the braking means 5 is locked in the slider and the other end of the braking means 5 is locked in the case side. Incidentally, the invention of the first aspect is specified with the assumption of the above-mentioned structure. Both this structure and operation can be also easily understood according to the following structures, so that the explanation of the third structure itself is also omitted.

(Retracting Unit)

In the retracting unit 6, as shown in FIGS. 1(a) to 3, the case 1 integrally forms a space portion 10 whose upper side is open, and attaching portions 10a projecting into the right and left of the space portion 10 and attached to a main body side. Also, the case 1 includes the cover 15 closing the space portion 10. The space portion 10 is formed in a slender short container shape, and divided by a lower surface 11, both side surfaces 12, and right-and-left end portions 13. On the lower surface 11, a guide bore 11a located in the middle in width and extending to right and left; a slider guide groove 11b whose cross-sectional surface has an approximately depressed shape; and a latch guide portion 14 whose cross-sectional surface has an approximately L shade, are provided. Among those, the slider guide groove 11b and the latch guide portion 14 are provided in such a way as to face the lower surface of the cover 15 as well (not shown).

Specifically, the guide bore 11a of the lower surface 11 penetrates up and down and moves and guides the projecting bodies 8 into the case. The guide groove 11b is a straight groove provided between the end portion 13 and the end portion 13 facing each other at one side of the guide bore 11a. Then, the guide groove 11b of the lower surface 11 and a guide groove of the cover 15 guide the sliding of the sliders 2A, 2B in a state of being fitted in a projection 22 or 32 provided on upper and lower surfaces of the sliders 2A, 2B. The guide portion 14 is provided along a bore border of the guide bore 11a on the other side of the guide bore 11a. Also, the guide portion 14 of the lower surface 11 and a guide portion of the cover 15 comprise a pair of straight grooves 14a respectively parallel to the guide bore 11a, and locking grooves 14b with an approximately L shape provided on both sides of the straight grooves 14a. Then, the latches 4 include a projected portion 52 provided on the upper and lower surfaces described hereinafter, and in a state in which the projected portion 52 is fitted, the projected portion 52 guides the sliding of the latches 4 along the straight grooves 14a. Also, the projected portion 52 locks the sliding of the latches 4 (and the sliders) by engaging the locking grooves 14b. Incidentally, the reference numeral 12b represents a streaky wall portion dividing the locking grooves 14b, and a wall portion which divides the locking grooves 14b is formed one step higher than the streaky wall portion so as to prevent abrupt disengaging when the projected portion 52 of the latches 4 is engaged.

On both side surfaces 12 on the case side and both sides 17 on a cover side, hook-like locking portions 12a and bore-like engaging portions 17a are provided with multiple pairs so as to be engaged with each other when the cover 15 is placed in the space portion 10. Also, on attaching portions 10b on the case side and right-and-left end surfaces 18 on the cover side, depressed locking portions 10d and projected engaging pieces 18a are provided so as to be engaged with each other when the cover is placed in the space portion 10. In this example, the cover 15 is integrated into the case 1 through the above-mentioned engagements. Incidentally, among the case 1, the right-and-left attaching portions 10a have a cross section in a width direction which forms an inverted depression, and the projecting bodies 8 can slide along the guide bore 11a from the inverted depression thereof.

The sliders 2A, 2B are placed in a space between the lower surface 11 on the case side and the cover 15. As shown in FIGS. 2 to 5(b), the sliders 2A, 2B form a resin block shape comprising latching supporting portions 20, 30 and braking-means connecting portions 21, 31 which are integrated into one side of the supporting portions through connecting portions 20a, 30a.

Incidentally, as the braking means 5, a piston-type and damper-type is used. This piston-type damper may be a heretofore known piston-type damper (for example, a piston-type damper described in Japanese Patent Application Laid-Open Publication No. 2006-29564). The piston-type damper may have a structure so as to include a cylinder 50 and a piston rod 51 which gradually comes in and out of the cylinder 50, and gentry drive relative to the cylinder 50 wherein the piston rod 51 is fixed, or gradually drive relative to the piston rod 51 wherein the cylinder 50 is fixed. However, the cylinder 50 includes a neck-like locking groove (not shown) on an outer circumference of a back end, and the piston rod 51 includes a neck-like locking groove on an outer circumference of an end. Also, in this example, because the piston-type damper is used as the braking means 5, both sliders 2A, 2B have an irregular shape. However, in a case such as when a rotary-type damper is used as the braking means, the sliders 2A, 2B can be set in the same shape.

The sliders 2A, 2B is common in that the connecting portions 21, 31 form one portion of upper and lower surfaces 2a, 2b, or 3a, 3b; that the sliders 2A, 2B include the projection 22 or 32 provided on the upper and lower surfaces 2a, 2b of the connecting portion 21, or on the upper and lower surfaces 3a, 3b of the connecting portion 31, and extending to right and left; that the supporting portions 20, 30 include guide portions 20b, 30b with circular cross sections which are provided on side surfaces of the inside, and guide the cylinder 50; that the supporting portions 20, 30 include a groove 23 or 33 on the upper and lower surfaces, and the groove 23 or 33 is provided in a portion which is one step lower than the upper and lower surfaces 2a, 2b, or 3a, 3b, and controls the movement of the latches 4; that the supporting portions 20, 30 include a latching-holding portion 25 or 35, and the latching-holding portion 25 or 35 is projected from the upper surface which is further lowered, and locks an end portion corresponding to a coil spring which is the biasing means 3; that the supporting portions 20, 30 include an axis portion 26 or 36 on the upper and lower surfaces which is provided near the groove 23 or 33, and as shown in FIGS. 10(a), 10(b), pivotally supports the latches 4 so as to be capable of rotating; that multiple projections 27, 37 projecting from outside surfaces of the supporting portions 20, 30, are included; and that an outside projected portion 28 or 38, which is located on a lower surface side of the supporting portions 20, 30 and provided near the axis portion 26 or 36, or the groove 23 or 33, is included, and an inside small projected portion 29 is included.

Among those, each- projection 22, 32 extends in a straight line, and fits in the above-mentioned guide groove 11b on the case side and the guide groove on a cover 15 side. Each groove 23, 33 is divided by an approximately L-shaped wall portion, and opens at a side facing the axis portion 26 or 36. The latching-holding portions 25, 35 and the axis portions 26, 36 are located on the right and left sandwiching each groove 23, 33. The projected portions 28, 38 are slid along the guide bore 11a on the case side, and the small projected portion 29 is slid along the straight grooves 14a of the guide portion 14 on the case side. Also, the connecting portion 21 of the slider 2A includes an insert bore 24a provided on an inner end surface, and an escape portion 24b which is notched toward the insert bore 24a from the outside. On the other hand, the connecting portion 31 of the slider 2B includes an approximately U-shaped clamp portion 34a provided by maintaining a gap 34b between the inner end surface.

The latches 4 are rotatably assembled to the above-mentioned sliders 2A, 2B as supporting points of the axis portions 26, 36. As shown in FIG. 2, in the latches 4, the latch used for the slider 2A and the latch used for the slider 2B have a symmetric shape. Among the drawings, FIGS. 6(a) to 7(c) show the latch on the slider 2A side, and FIGS. 10(a) to 11(b) show the latch on the slider 2B side. Here, the latches will be explained based on FIGS. 6(a) to 7(c). Specifically, the latch 4 is a resin molded product and integrally includes a supporting portion 40 pivotally supporting to a slider side; an engagement portion 42 provided in one side of the supporting portion 40 and engaging the projecting bodies 8 which are the operation members at a normal time; and auxiliary engagement means 47 located on a lower surface side of the latch and provided on an end 45 side rather than the engagement portion 42.

Among those, as shown in FIG. 6(d), the supporting portion 40 has an approximately depressed shape with a notch 40a except for upper and lower portions and an engagement portion 42 side, and includes a projection 40b projecting to the inside of the depressed shape; an axis bore 43 formed by penetrating into the upper and lower portions; and projections 44, 44 respectively extended in a horizontal direction from the upper and lower portions. The engagement portion 42 is provided on one side of the supporting portion 40 with an approximately U shape. Also, in a portion C forming the engagement portion 42, the upper surface side in FIG. 6(a) is one step lowered, and the lower surface side in FIG. 6(c) becomes one surface with an outer surface of the supporting portion 40.

The auxiliary engagement means 47 engages the projecting bodies 8 when the latch 4 comes to the retracted state of a non-engaged state by an improper operation, so that the latch 4 can be switched from the retracted state to the standby state. In this example, as schematically shown in FIGS. 12(a), 12(b), the auxiliary engagement means 47 is formed in a different level in which an end side of the lower surface of the latch 4 is significantly dropped, and structured by an inclined-surface guide portion 47a on an end side guiding the projecting bodies 8, and a depressed portion 47b which continues into the inclined-surface guide portion 47a and is one level deepened. The inclined-surface guide portion 47a is tapered so as to be lowered as moving to the end. In a usage mode, when the projecting bodies 8 abut against the inclined-surface guide portion 47a upwardly, the projecting bodies 8 slide along the inclined-surface guide portion 47a while reducing a projecting amount, and when the projecting bodies 8 enter into the depressed portion 47b, the projecting bodies 8 increase the projecting amount again so as to maintain an engagement with the depressed portion 47b.

Also, in the above-mentioned latch 4, the portion C forming the engagement portion 42 is structured by a material different from that of the other portions. In this example, the portion C forming the engagement portion 42 is structured by a soft resin material which is softer than the other portions. Specifically, the latch 4 is molded by a two-material molding method. Latch aggregates (portions except for the portion C) are hard resin portions such as an ABS (acrylonitrile butadiene styrene polymer) and the like formed by a primary molding. The portion C forming the engagement portion 42 is a soft resin portion such as polyester elastomer or polypropylene elastomer and the like formed by a secondary molding. This tends to easily generate a noise when the projecting bodies 8 hit a U-shaped corresponding portion of the engagement portion 42. However, by forming the U-shaped corresponding portion by the soft resin portion, such a hitting noise can be prevented. Incidentally, as for another material structure, the portion C forming the engagement portion 42 can be configured by a resin material harder than that of the portions except for the portion C. In that case, durability of the engagement portion 42 can be improved.

(Operation Members)

As shown in FIGS. 8(a), 8(b), the projecting bodies 8 which are the operation members can freely come in and out relative to the sliding doors A(B) which are the mobile bodies through a biasing force, i.e., have a structure reducing the projecting amount against the biasing force when the projecting bodies 8 receive a load. The structure of FIG. 8(b) includes the projecting body 8, a supporting portion 38 with a cylindrical shape with a bottom, a biasing spring 37, and a retaining member 36. Among those, the projecting body 8 is projected from an upper end surface of the supporting portion 38. The supporting portion 38 has an inside which is a hollow 38a where the biasing spring 37 is placed, and a projected portion 38b on an opposing lateral surface. The retaining member 36 comprises a cylindrical shape with a bottom, projects an attaching portion 36c around the top of the cylinder, and forms a bore portion 36b on an opposing lateral surface. Then, the supporting portion 38 is pushed into the bore portion 36b of the retaining member 36 relative to the retaining member 36 in a state in which the biasing spring 37 is placed inside the supporting portion 38, and the projected portion 38b is engaged with the bore portion 36b so that a retaining process is carried out. In this assembled state, the projecting body 8 projects up to the maximum due to a biasing force of the biasing spring 37 relative to the retaining member 36 with the supporting portion 38. For example, when the projecting body 8 receives a downward load, the projecting body 8 reduces the projecting amount against the biasing force of the biasing spring 37. Incidentally, the projecting body 8 of the present invention may be a structure in which the projecting body 8 comes in and out upwardly and downwardly through the biasing force, for example, a guide axis structure disclosed in Japanese Patent Application Laid-Open Publication No. 2007-107301 or a structure similar to that.

(Assembly)

After the above-mentioned respective members, for example, each latch 4 is pivotally supported to the sliders 2A, 2B, both the sliders 2A, 2B are attached to the piston-type damper which is the braking means 5. Next, the above-mentioned members are assembled to the case 1 with the biasing means 3, and the cover 15 is attached to the case 1 so as to be completed as the retracting unit 6.

First, each latch 4 is rotatably supported relative to the sliders 2A, 2B by fitting each axis bore 43 and each axis portion 26, or each axis bore 43 and each axis portion 36. After that, both the sliders 2A, 2B are connected through the piston-type damper which is the braking means 5. In this case, the piston rod 51 is connected to the connecting portion 21 of the slider 2A in a state in which the end of the piston rod 51 is inserted into the insert bore 24a by engaging a retaining ring 52 and the like shown in FIG. 2 with the locking groove around the outer circumference of the end of the above-mentioned rod from the escape portion 24b. The cylinder 50 is connected to the connecting portion 31 of the slider 2B by engaging the above-mentioned locking groove on a cylinder side with a clamp portion 34.

Next, the sliders 2A, 2B with the above-mentioned latch 4, the braking means 5, and the biasing means 3 are provided as a pair, placed relative to the case 1, and covered by the cover 15. Here, for example, in FIGS. 2, 10(a), 10(b), the slider 2A and the slider 2B fit the corresponding projection 22 or the projection 32 relative to the guide groove 11b on the case side, and each latch 4 fits the corresponding projected portion 46 relative to the guide portion 14 on the case side. From this state, the coil spring which is the biasing means 3 is placed between the sliders 2A and 2B. Specifically, one end of the coil spring is locked in the latching-holding portion 25 of the slider 2A, and the other end of the coil spring is locked in the latching-holding portion 35 of the slider 2B.

From the above-mentioned state, for example, the slider 2A and the slider 2B are positioned away from each other up to the maximum against the biasing force of the biasing means 3. Also, the projected portion 46 of the latch 4 on the slider 2A side is engaged with one locking groove 14b, and the projected portion 46 of the latch 4 on the slider 2B side is engaged with the other locking groove 14b. In this process, the latch 4 on the slider 2A side and the latch 4 on the slider 2B side are rotated and switched from a state in which an end side of the latch 4 approaches the slider side, i.e., the retracted state in which the end side of the latch 4 is engaged with the projecting body 8 as shown in FIGS. 11(a), 11(b), to a state in which the end side of the latch 4 is positioned away from the slider side as the supporting point of the axis portion 26 or 36, i.e., the standby state or a non-retracted state in which the end side of the latch 4 is disengaged from the projecting body 8 as shown in FIGS. 10(a), 10(b). In the retracted state, the retracted state is maintained in a state wherein the latch 4 fits the projections 44 in the groove 23 of the slider 2A, or the groove 33 of the slider 2B. At the end, the cover 15 is attached to the case 1 by a pressing operation.

(Operation)

As for the sliding assist mechanism, in the above-mentioned assembled state, each slider 2A, 2B and each latch 4; the braking means 5; and the biasing means 3 are sandwiched between the lower surface 11 on the case side and the lower surface of the cover 15. Each slider 2A, 2B is fitted in the guide groove 11b where the upper and lower projections 22, 32 correspond, and slid while maintaining the fitted state. Each latch 4 is fitted in the guide portion 14 where the upper and lower projected portions 46 correspond, and when each projected portion 46 is fitted in the straight groove 14a, the latch 4 comes to the above-mentioned retracted state. When each projected portion 46 is engaged with the locking groove 14b, the latch 4 is switched to the above-mentioned standby state.

Next, a concrete operation will be described in detail with reference to FIGS. 8(a) and 9(a) to 12(b). Incidentally, FIGS. 9(a) to 9(c) schematically show a case in which the above-mentioned sliding assist mechanism is applied to the double sliding doors shown in FIG. 8(a), and the reference numeral 70 suggests guide rails on upper sides of sliding door frames provided in the opening on the main body 7 side. FIG. 9(a) is a fully opened state of the opening of the sliding doors A, B; FIG. 9(b) is a fully closed state of the opening of the sliding doors A, B; and FIGS. 9(a), 9(b) show schematic positional relationships of the retracting unit 6 attached to a guide rail 70 side and each projecting body 8 provided in the sliding doors A, B.

(1) In a case such as when the opening is fully opened by moving the sliding doors A, B from the position shown in FIG. 9(b) to the position shown in FIG. 9(a), the sliding door A is operated to be moved to the right side, and the sliding door B is operated to be moved to the left side. Then, when the sliding door A is moved up to the middle, the slider 2B on the right side is slid to the right side by interlocking the movement of the projecting body 8 engaging the latch 4 (which is in the retracted state), and the projected portion 46 on a latch side enters into the locking groove 14b from the straight groove 14a in FIG. 11(a). Then, as shown in FIGS. 10(a), 10(b), the latch 4 of the slider 2B is switched to the standby state by engaging the projected portion 46 with the locking groove 14b while rotating counterclockwise as the supporting point of the axis portion 36. In this process, biasing forces are accumulated in the biasing means 3.

After that, the projecting body 8 on the left side of the sliding door A corresponds to the corresponding portion of the engagement portion 42 of the latch 4 (which is in the standby state) of the slider 2A. The latch 4 is rotated counterclockwise as the supporting point of the axis portion 26 by stress thereof, and each projected portion 46 is unlocked from the locking groove 14b and fitted in the straight groove 14a so as to be switched to the retracted state in which the projecting body 8 is engaged with the engagement portion 42 as in the case of FIG. 11(a). Then, the slider 2A is retracted toward the slider 2B with the latch 4 due to the biasing force of the biasing means 3, so that the sliding door A is switched to the closed position in FIG. 11(a). In this case, in the slider 2A, the projection 22 is guided along the guide groove 11b, and in the latch 4, the projected portion 46 is guided along the straight groove 14a. Incidentally, the sliding door B is also switched to the closed position in a similar fashion of the sliding door A. Also, in this embodiment, when the sliding doors A, B are moved due to the biasing force of the biasing means 3, the sliding doors A, B are gradually slid by receiving the braking of the above-mentioned braking means 5.

(2) In a case such as when the opening is fully closed by moving the sliding doors A, B from the position shown in FIG. 9(a) to the position shown in FIG. 9(b), the sliding door A is operated to be moved to the left side, and the sliding door B is operated to be moved to the right side. For example, when the sliding door A is moved up to the middle, the slider 2A on the left side is slid to the left side by interlocking the movement of the projecting body 8 engaging the latch 4 (which is in the retracted state), and the projected portion 46 on the latch side enters into the locking groove 14b from the straight groove 14a shown in FIG. 11(a). Then, as shown in FIGS. 10(a), 10(b), the latch 4 of the slider 2A is switched to the standby state by engaging the projected portion 46 with the locking groove 14b while rotating counterclockwise as the supporting point of the axis portion 36. In this process, the biasing forces are accumulated in the biasing means 3.

After that, the projecting body 8 on the right side of the sliding door A corresponds to the corresponding portion of the engagement portion 42 of the latch 4 (which is in the standby state) of the slider 2B side. The latch 4 is rotated clockwise as the supporting point of the axis portion 36 by stress thereof, and each projected portion 46 is unlocked from the locking groove 14b and fitted in the straight groove 14a so as to be switched to the retracted state in which the projecting body 8 is engaged with the engagement portion 42 as in the case of FIG. 11(a). Then, the slider 2B is retracted toward the slider 2A with the latch 4 due to the biasing force of the biasing means 3, so that the sliding door A is switched to the closed position in FIG. 11(b). In this case, in the slider 2B, the projection 32 is guided along the guide groove 11b, and in the latch 4, the projected portion 46 is guided along the straight groove 14a. Incidentally, the sliding door B is also switched to the closed position in a similar fashion as the sliding door A. Also, in this embodiment, when the sliding doors A, B are moved due to the biasing force of the above-mentioned biasing means 3, the sliding doors A, B are gradually slid by receiving the braking of the above-mentioned braking means 5.

(3) FIG. 9(c) suggests a case in which the latch 4 on the slider 2A side is abruptly unlocked from the locking groove 14a due to an impact and the like when, for example, the sliding door A starts to move in an arrow direction (right side) from the state in FIG. 9(b). In this embodiment, when such an improper operation occurs, the auxiliary engagement means 47 can easily repair to a regular state.

Specifically, this repairing operation moves the sliding door A further in the arrow direction, i.e., operates to move the sliding door A up to just before the state in FIG. 9(a). In this case, the latch 4 on the slider 2A side is in the retracted state as shown in FIGS. 12(a), 12(b). When the sliding door A is operated to be moved to the right side, the projecting body 8 on the left side provided in the sliding door A enters into the inclined-surface guide portion 47a of the auxiliary engagement means 47 as in the case of FIG. 12(a). After the projecting body 8 slightly reduces the projecting amount against the biasing force of the above-mentioned biasing spring 37 in response to an inclined angle of the inclined-surface guide portion 47a, the projecting body 8 increases the projecting amount again, and engages the depressed portion 47b which is one level deepened.

At this time, as shown in FIG. 9(b), the sliding door A is operated to be moved to the left side. Due to this movement, after the projected portion 46 on the latch side reaches an entrance of the locking groove 14b from the straight groove 14a of the guide portion 14, the projecting body 8 is disengaged from the depressed portion 47b through operations in which the projecting body 8 comes in and out due to the biasing spring 37 (reducing the projecting amount once against the biasing force of the biasing spring 37, and increasing the projecting amount again due to the biasing force). Then, the latch 4 of the slider 2A is switched to the standby state by engaging the projected portion 46 with the locking groove 14b while rotating clockwise as the supporting point of the axis portion 26 due to a reaction force at the time of disengagement thereof. Thereby, the latch 4 of the slider 2A and the latch 4 of the slider 2B are repaired relative to the sliding door A in the state of FIG. 9(a). This kind of repairing structure is simple compared to the Patent Document 1, and since the projecting body 8 comes in and out upwardly and downwardly through the biasing force, the repairing structure can be easily applied even in a case in which a thickness of the sliding doors A (B) is thin, and also is not susceptible to wobbling and the like of the door.

### MODIFIED EXAMPLES

FIGS. 13(a), 13(b) show modified examples of the auxiliary engagement means 47 which is the above-mentioned repairing structure. In this explanation, only modified portions are clarified by providing the same symbols in the same portions as those of the above-mentioned embodiment.

(1) A latch 4A in FIG. 13(a) includes an engaging bore portion 48 which is provided on an end side, and elastically engages and disengages the projecting body 8. In this structure, the projecting body 8 may be a simple axis or pin. However, the setting of engagement degree and engagement strength of the projecting body 8 relative to the engaging bore portion 48 becomes important.

(2) A latch 4B in FIG. 13(b) includes a magnet 49 which is provided on an end side, and attaches and detaches the projecting body 8 by a magnetic force. In this structure, the projecting body 8 may be a simple metallic axis or pin. However, the setting of a level of adsorption between the magnet 49 and the projecting body 8 becomes important.

(3) As for the other modified example (not shown), in regard to the above-mentioned latch, the end side of the latch is divided and the latch is structured by a latch main body and a divided portion. Also, the divided portion is pivotally supported to be capable of rotating and elastically returning relative to the latch main body. Then, when the projecting body hits the divided portion, the divided portion is reversed against a biasing force, so that the projecting body 8 can be engaged with the above-mentioned engagement portion 42. Such a structure can be considered as well. As mentioned above, the present invention can be modified accordingly except for requirements specified in claims.

The present invention is based on Japanese Patent Application No. 2008-149908 filed on Jun. 6, 2008, and all contents thereof are incorporated in their entirety herein as a reference.

### EXPLANATION OF SYMBOLS

1 case
2, 2A, 2B sliders
3 biasing means
4, 4A, 4B latches
5 braking means
6 retracting unit
7 main body
8 projecting bodies (operation members)
14 guide portion
14a straight grooves
14b locking grooves
15 cover
22, 32 projections
26, 36 axis portions
25, 35 latching-holding portions
36 retaining member
37 biasing spring
38 supporting portion
40 supporting portion
42 engagement portion
47 auxiliary engagement means
47a inclined-surface guide portion
47b depressed portion
48 engaging bore portion (auxiliary engagement means)
49 magnet (auxiliary engagement means)
50 cylinder
51 piston rod
A, B sliding doors (mobile bodies)

1. A sliding assist mechanism, comprising:
a case attached to one of a main body and a mobile body;
a latch movably disposed in the case and switched between a standby state in which the latch is locked in a corresponding portion inside the case and a retracted state in which the locking is released;
biasing means for biasing the latch in one direction; and
an operation member attached to the other of the main body or the mobile body, and switching the latch from the standby state to the retracted state, or from the retracted state to the standby state;
wherein when the latch is switched from the standby state to the retracted state, the sliding assist mechanism allows the mobile body to move from a first position to a second position on a main body side through the operation member by a biasing force accumulated in the biasing means, and
the latch includes an engagement portion for a normal time, engaging the operation member in association with switching from the standby state to the retracted state, and auxiliary engagement means which engages the operation member to be capable of releasing when the latch comes to the retracted state in a non-engaged state of the operation member relative to the engagement portion.

2. A sliding assist mechanism, comprising:
a case attached to one of a main body and a mobile body;
a pair of latches respectively disposed in the case to be movable, and switched between a standby state in which the latches are locked in a corresponding portion inside the case and a retracted state in which the locking is released;
biasing means for biasing in a direction in which both latches approach to each other; and
an operation member attached to the other of the main body or the mobile body, and switching the latches from the standby state to the retracted state, or from the retracted state to the standby state;
wherein when the mobile body is moved to a middle of the movement from a first position to a second position on a main body side or up to the middle from the second position to the first position, one latch releases the locking through the operation members, and with the operation member, the sliding assist mechanism allows the mobile body to move up to the second position or the first position with an approaching drive through a biasing force of the biasing means toward the other latch, and
the latch includes an engagement portion for a normal time, engaging the operation member in association with switching from the standby state to the retracted state, and auxiliary engagement means which engages the operation member to be capable of releasing when the latch comes to the retracted state in a non-engaged state of the operation member relative to the engagement portion.

3. A sliding assist mechanism according to claim 1, wherein the sliding assist mechanism further include a slider slidably disposed relative to the case, and rotatably supporting the latch.

4. A sliding assist mechanism according to claim 1, wherein the operation member is a projecting body provided so as to be capable of coming in and out relative to the mobile body through a biasing force, and wherein the auxiliary engagement means comprises an inclined-surface guide portion formed in the latch and guiding the projecting body, and a depressed portion which continues into the inclined-surface guide portion.

5. A sliding assist mechanism according to claim 1, wherein the auxiliary engagement means absorbs and engages the operation member by a magnetic force.

6. A sliding assist mechanism according to any of claim 1, wherein the latch has a portion forming the engagement portion made by a material different from that of the other portions.

7. A sliding assist mechanism according to claim 6, wherein the portion forming the engagement portion is formed so as to be softer than the other portions.
